(19) United States
(12) Patent Application Publication
(10) Pub. No.: US 2007/0101923 A1
(43) Pub. Date: May 10, 2007

(54) Poochie-bells

(76) Inventor: Cheryl Pedersen, Simsbury, CT (US)

Correspondence Address: MCCORMICK, PAULDING & HUBER LLP, CITY PLACE II, 185 ASYLUM STREET, HARTFORD, CT, 06103, US

(21) Appl. No.: 11/350,440

(22) Filed: Feb. 10, 2006

Related U.S. Application Data
(60) Provisional application No. 60/593,967, filed on Feb. 28, 2005.

(51) Int. Cl. G08B 3/00

(52) U.S. Cl. 116/67 R; 116/170

(57) ABSTRACT

A pet alarm device for alerting pet owners includes a main body adapted to hang from a door handle and at least one signal device secured onto the main body to alarm pet owners that a pet would like to enter or exit through the door. The signal devices are bells of substantially spherical shape and fabricated from reinforced steel.

### BACKGROUND OF THE INVENTION

1. Field of the Invention

The present invention relates to pet alarms in general and, more particularly, to lightweight, low-cost mechanical alarms for pets.

2. Brief Description of Related Technology

Current devices that allow a pet to communicate its need to go outside or inside include doormats wherein the pet steps on the doormat to alert its owner. The doormat typically contains electrical wiring, which sends an auditory signal when the pet steps on the doormat. These doormat devices may be used outside or inside a door. If used outside a door, the doormats may be exposed to weather and elements, and thus the internal electrical wiring may be susceptible to weather damage. The doormats typically require battery power, which must be replaced at certain intervals of time. Moreover, the doormats can be expensive. Therefore, a need in the art exists for a non-powered, inexpensive pet alarm device that is not susceptible to weather damage.

Pet chimes are yet another device whereby pets may communicate their need to go outside with their owner. The pet chime device is battery operated and includes a wireless doorbell and a remote control transmitter. In operation, the pet owner places the remote control transmitter on the floor or wall near a door. The pet is then trained to place its paw or mouth on the remote control transmitter, which sends a radio frequency signal to activate the wireless doorbell up to a distance of 100 feet. Several disadvantages are inherent in the pet chime device. Like the doormat device, the pet chime device is battery powered, and is susceptible to discontinued operation when the battery dies. Also like the doormat device, the pet chime device is relatively expensive. Finally, the remote control transmitter must be placed within 100 feet from the wireless doorbell in order to activate the wireless doorbell. Large homes with multiple doors may require more than one pet chime device.

In addition to doormats and door chime devices, pet owners may hang hotel bells on door handles and train their pets to activate the hotel bell. Alternatively, the pet owners can place the hotel bell on the floor for their pet to step on. The hotel bell is comprised of a simple loop of rigid material that is fixedly attached to a single bell.

Several disadvantages exist to a hotel bells used as a pet alarm device. For example, the fixed nature of the loop enables the bell to be slipped over a simple knob-shaped door handle, but does not enable the loop to be opened, slid through a D-shaped door handle and closed around the D-shaped door handle. In addition, the hotel bells include only one bell, which is located near the door handle when the bell is hung on the door handle. Small pets are unable to reach and activate the hotel bells. Another disadvantage is that the door could be scratched and damaged if the pet tugs on the bell. Moreover, the loop could break because the loop is rigid and provides no yield when the pet tugs on the bell. Furthermore, the hotel bell is fixedly attached to the loop and is not replaceable, and thus a broken loop would render the entire device useless. Additionally, the loop of the hotel bell may be large enough for the pet to inadvertently slip its neck or a paw through the loop, resulting in injury to the pet. If the hotel bell is placed on the grounds, the pet or pet owner could trip on the hotel bell, and the device could become lost. Finally, the bells utilized in hotel bells are not designed especially for pets, and thus are not reinforced to prevent against being crushed by the pet.

### SUMMARY OF THE INVENTION

According to the present invention, a pet alarm device for alerting pet owners includes a main body adapted to hang from a door handle and at least one signal device secured onto the main body and adapted to alarm pet owners. The main body of the pet alarm device includes an elongate flexible support and a first loop adapted to being hung from a door handle. One or more signal devices can be bells which are substantially spherical and preferably fabricated from reinforced steel. The main body is fabricated from either ribbon, cord or elastic material and is adapted to provide yield should the pet tug on the device.

According to feature of the present invention, a replacement main body for the pet alarm device can be provided. The replacement main body includes a main body adapted to be hung from a door handle.

These and other features, objects, and advantages of the present invention will be better understood in view of the drawings and detailed description.

### BRIEF DESCRIPTION OF THE DRAWINGS

FIG. 1 is a front view of one embodiment of the device according to the present invention;

FIG. 2 is a side view of the device shown in FIG. 1;

FIG. 3 is a perspective view of the device shown in FIG. 1, as used by a small pet;

FIG. 4 is a perspective view of the device shown in FIG. 1, as used by a large pet;

FIG. 5 is a front view of a replacement ribbon; and

FIG. 6 is a side view of the replacement ribbon of FIG. 5.

### DETAILED DESCRIPTION OF EMBODIMENTS

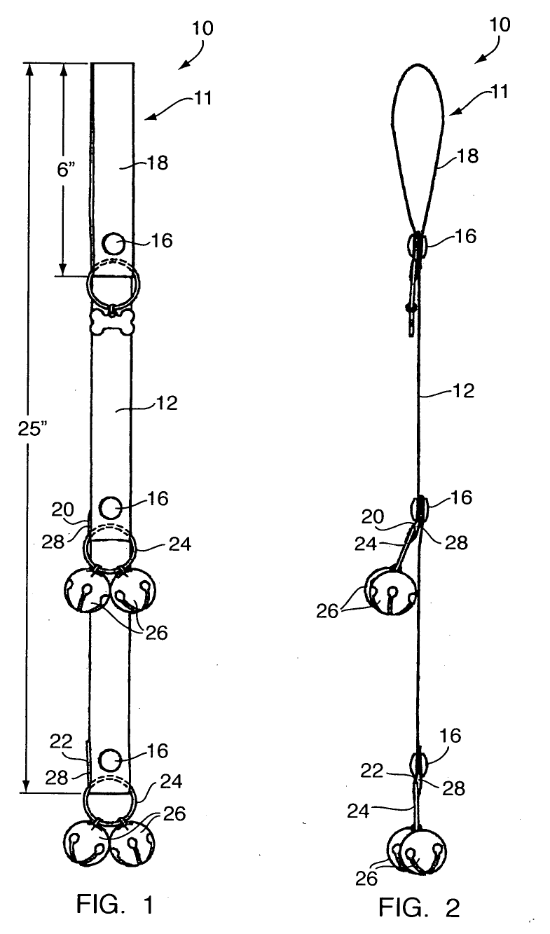

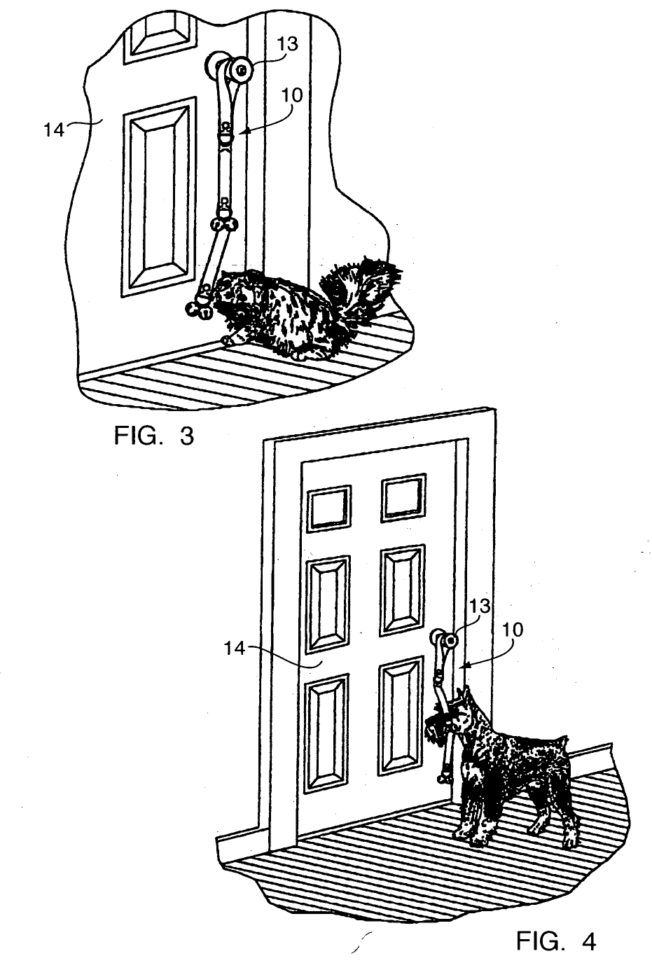

Referring to FIGS. 1-4, a pet alarm device 10 includes a main body 11 comprised of a flexible support 12 adapted to being hung on a door handle 13 of a door 14. The flexible support 12 is preferably elongate and is preferably fabricated of grosgrain ribbon, which provides aesthetic qualities to the pet alarm device 10. As may be appreciated, any type of flexible support 12 may be used, including, but not limited to, rope, fabric, cordage, belting, elastic, and leather. The flexible support 12 should be a length that clears the floor yet allows the pet alarm device 10 to be accessible to pets of different size. For example, a good length for the pet alarm device 10 is approximately 25 inches because this length prevents the pet alarm device 10 from hitting the floor when hung on a door handle 13, while allowing pets of different size to reach the pet alarm device 10, as shown in FIGS. 3 and 4.

As shown in FIGS. 1 and 2, the flexible support 12 includes a first loop 18 adapted for securing the pet alarm device 10 to the door handle 13. Alternatively, the first loop 18 may be adapted to being hung from a hook mounted to a wall, or to any suitable surface. Preferably, the first loop 18 is provided by securing a detachable fastener 16 to the flexible support 12 at approximately 12 inches from the top of the flexible support 12, thereby resulting in an approximate 6 inch loop. The detachable fastener 16 is disengageable, and provides a means for attaching the pet alarm device 10 to a variety of door handle shapes. For example, the detachable fastener 16 may be disengaged to slide the pet alarm device 10 through a D-shaped door handle 13 and reengaged to secure the first loop 18 around the D-shaped door handle 13.

The flexible support 12 may also include one or more additional loops 20, 22. The additional loops 20 and 22 are provided by securing detachable fasteners 16 to the pet alarm device 10 at different lengths relative to the floor. The detachable fasteners 16 are disengageable, thereby lengthening the pet alarm device 10 when open. Moreover, in the event that the pet tugs or pulls on the pet alarm device 10, the detachable fasteners 16 will disengage, thereby providing yield to the pet alarm device 10. Disengagement of the detachable fasteners 16 prevents the pet alarm device 10 from tearing or breaking. Suitable detachable fasteners 16 include, but are not limited to, snaps, hook-and-loop fasteners such as Velcro® fasteners (Velcro is a registered trademark of Velcro Industries B.V.), and buttons.

Referring to FIGS. 1 through 4, the pet alarm device 10 also includes one or more signal devices 26 that may be activated by the pet. As shown in FIGS. 1 and 2, the signal devices 26 in the preferred embodiment are bells. More particularly, the signal devices 26 utilized in the present invention may be bells made of reinforced steel. The reinforced steel prevents the pet from crushing the bells with its mouth. In addition, the signal devices 26 may be bells of spherical shape. The spherical shape of the bells prevents the pet from damaging the door 14 when the bells come into contact with the door 14. It may be readily appreciated, however, that the signal devices 26 may be any type of device that make noise when activated and provides a means for a pet to indicate a need to go outside to its pet owner.

The signal devices 26 may be attached to the pet alarm device 10 at any suitable length, that is, at any length accessible by the pet. Preferably, the signal devices 26 are attached to the pet alarm device 10 at approximately 8 inches and 18 inches from the floor, thereby providing access to pets of different size. As shown in FIGS. 3 and 4, smaller pets may use the lower set of signal devices 26 and larger pets may use the higher set of signal devices 26. Moreover, since the pet alarm device 10 is flexible, a pet can use the device by batting with its paws or by pulling with its mouth.

As shown in FIGS. 1 and 2, the signal devices 26 may be fastened to the main body 11 by detachable members 24. The flexible support 12 of the main body 11 includes one or more openings 28 that are adapted to receive the detachable members 24. Providing the signal devices 26 on detachable members 24 allows the signal devices 26 to be removed from the main body 11. The detachable members 24 may be slid into or out of the openings 28. This may be desirable if the main body 11 is damaged for any reason, or if the pet owner wishes to use a main body 11 of different aesthetic appearance. As shown in FIGS. 1 and 2, the detachable members 24 are split rings. It may be appreciated, however, that the detachable members may be any type of device that allows the signal devices 26 to be attached to and removed from main body 11. It may also be appreciated that the signal devices 26 may be fastened directly to the main body 11, thereby eliminating the need for detachable members 24. For example, the signal devices 26 may be sewn directly onto the flexible support 12 of the main body 11.

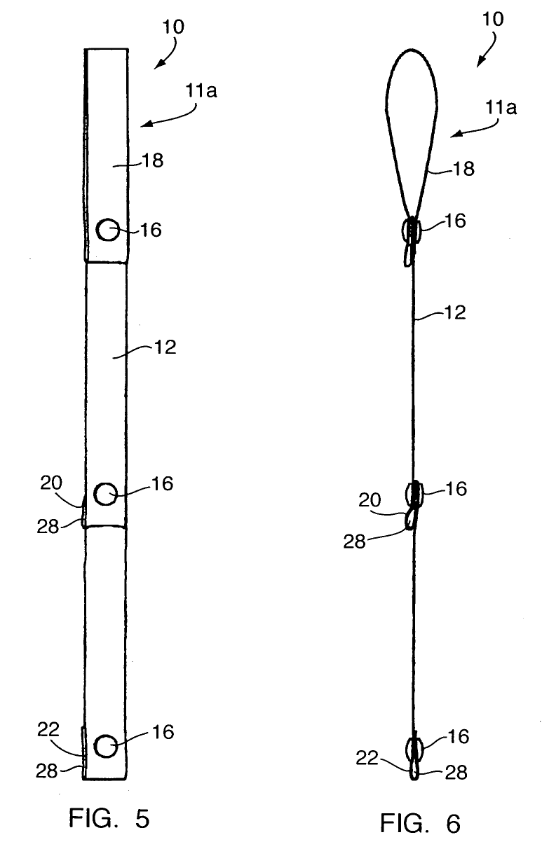

Referring to FIGS. 5-6, the present invention includes a replacement main body 11a. The replacement main body 11a is comprised of an elongate flexible support 12. Preferably, the flexible support 12 is a grosgrain ribbon having a first loop 18 for securing the pet alarm device 10 to a door handle 13. The first loop 18 may be provided by securing a detachable fastener 16 to the flexible support 12 at approximately 12 inches from the top of the flexible support 12, thereby resulting in a 6 inch loop that may be disengaged and slid through a variety of door handle shapes. The replacement main body 11a may also include one or more additional loops 20, 22 provided by securing detachable fasteners 16 to the flexible support 12. The additional loops 20, 22 provide yield to the replacement main body 11a when the pet tugs on the flexible support 12. The replacement main body 11a includes one or more openings 28 adapted to receive one or more detachable members 24, such as split rings, which provide a means for securing the signal devices 26 to the replacement main body 11a. Providing a replacement main body 11a allows the pet owner to change the aesthetic appearance of the existing main body 11. Additionally, providing a replacement main body 11a is also beneficial in the event that the main body 11 becomes overly worn or the pet chews on or otherwise destroys the main body 11.

In operation, the pet owner provides the pet access to the pet alarm device 10 by sliding the first loop 18 over a knob-shaped door handle 13, as shown in FIGS. 3 and 4. The first loop 18 may also be hung on a hook mounted to a wall. Alternatively, the pet owner may secure the pet alarm device 10 to a D-shaped door handle 13 by disengaging the detachable fastener 16, sliding the main body 11 through the D-shaped door handle 13 and reengaging the detachable fastener 16. The pet alarm device 10 may be hung inside or outside a door 14, as shown in FIGS. 3 and 4. A pet with a desire to go inside or outside may approach the pet alarm device 10 and put its nose, paw, mouth or other body part into contact with the pet alarm device 10. By contacting the pet alarm device 10, the pet activates one or more signal devices 26. Activation of the signal devices 26 sends an auditory signal to the pet owner, who is alerted of the pet's desire to enter or exit the house. Preferably, as shown in FIGS. 3 and 4, at least two sets of signal devices 26 are provided at different heights relative to the floor so that both small and large pets can activate the signal devices 26. Additionally, a replacement main body 11a is provided so the pet owner may optionally change the aesthetic appearance of the pet alarm device 10. The replacement main body 11a also prevents the device from becoming useless in the event that the pet chews on or otherwise destroys the main body 11. Preferably, the signal devices 26 are disposed on detachable members 24 to allow the signal devices to be removed from the main body and secured onto the replacement main body 11a.

The present invention offers many advantages over existing devices that allow pets to alert their owners of a need to go inside or outside. The primary advantage to the present invention is its lightweight, low-cost properties. For example, unlike battery-powered devices that lose functionality when the power source is depleted, the present invention is operable by mechanical means and therefore is not dependent on a power source. Other advantages of the present invention are certain safety features. For example, the first loop 18 and additional loops 20, 22 are too small for a pet to inadvertently slip its neck or paws through, thereby preventing strangulation or other forms of injury. Yet another advantage to the present invention is that it will not scratch or otherwise damage the door 14. For example, the signal devices 26 of the preferred embodiment are spherical shaped bells made of reinforced steel that will not scratch the door 14 if they come into contact with the door 14. Moreover, the detachable fasteners 16 provide yield to the pet alarm device 10. For example, in the event that the pet tugs on the pet alarm device 10, the detachable fasteners 16 will disengage, thereby reducing force on, and preventing damage to, the door handle 13. Still another advantage to the present invention is its accessibility to pets of different size. For example, as shown in FIGS. 3 and 4, the preferred embodiment of the present invention includes at least two sets of signal devices 26. The two sets of signal devices 26 are provided at different heights relative to the floor so that both small and large pets can easily contact the signal devices 26. Finally, providing a replacement main body 11a is another advantage to the present invention. For example, the pet alarm device 10 is not rendered useless if the main body 11 becomes damaged or worn. Moreover, providing a replacement main body 11a allows the pet owner to change the aesthetic appearance of the pet alarm device 10 according to his or her preference.

While the present invention has been described with reference to the preferred embodiments, it will be understood by those skilled in the art that various obvious changes may be made, and equivalents may be substituted for elements thereof, without departing from the essential scope of the present invention. Therefore, it is intended that the invention include all embodiments falling within the scope of the appended claims.

1. canceled

2. A pet alarm device for alerting pet owners, comprising:
a main body adapted to hanging from a door handle; and
at least one signal device secured onto the main body and adapted to alarm pet owners,
wherein the main body is comprised of an elongate flexible support, and
wherein the main body includes a first loop adapted to being hung from a door handle.

3. The pet alarm device of claim 2, wherein a plurality of signal devices are secured onto the main body and adapted to alarm pet owners.

4. The pet alarm device of claim 2, wherein the first loop may be opened to be adapted to different types of door handles.

5. The pet alarm device of claim 2, wherein the flexible support is a ribbon.

6. The pet alarm device of claim 2, wherein the flexible support is a cord.

7. The pet alarm device of claim 2, wherein the flexible support is elastic.

8. The pet alarm device of claim 2, wherein the signal devices are bells.

9. The pet alarm device of claim 8, wherein the bells are substantially spherical.

10. The pet alarm device of claim 8, wherein the bells are fabricated from reinforced steel.

11. The pet alarm device of claim 2, wherein the signal devices fastened to the mail body by detachable members.

12. The pet alarm device of claim 2, wherein the main body is a flexible support having at least one additional loop made disengageable by a detachable fastener.

13. The pet alarm device of claim 12, wherein the detachable fastener is a snap.

14. The pet alarm device of claim 12, wherein the detachable fastener is a button.

15. The pet alarm device of claim 12, wherein the detachable fastener is a hook-and-loop fastener.

16. A pet alarm device for alerting pet owners, comprising:
a main body adapted to hanging from a door handle; and
at least one detachable member; and
at least one signal device,
wherein the main body is comprised of an elongate flexible support,
wherein the main body includes a first loop adapted to being hung from a door handle,
wherein the main body includes at least one opening adapted to receive a detachable member, and
wherein the detachable member is attached to at least one signal device.

17. The pet alarm device of claim 16, wherein the detachable member is a split ring.

18. The pet alarm device of claim 16, wherein the first loop may be opened to be adapted to different types of door handles.

19. The pet alarm device of claim 16, wherein the main body is a flexible support having at least one additional loop made disengageable by a detachable fastener.

20. The pet alarm device of claim 19, wherein the detachable fastener is a snap.

21. A replacement main body for a pet alarm device comprising:
a main body adapted to hanging from a door handle;
wherein the main body is a flexible support having a first loop adapted to being hung from a door handle, and
wherein the main body includes at least one opening adapted to receive a detachable member having one or more signal devices.

22. The replacement main body of claim 21, wherein the flexible support is a ribbon.

23. The replacement main body of claim 21, wherein the flexible support includes at least one additional loop made disengageable by a detachable fastener.

24. The replacement main body of claim 21, wherein the first loop may be opened to be adapted to different types of door handles.
